(19) United States
(12) Patent Application Publication
(10) Pub. No.: US 2022/0203647 A1
(43) Pub. Date: Jun. 30, 2022

(54) VEHICLE OIL CONCRETE COVER

(71) Applicant: SHEILA MARIE HARGIS, OKLAHOMA CITY, OK (US)

(72) Inventor: SHEILA MARIE HARGIS, OKLAHOMA CITY, OK (US)

(21) Appl. No.: 17/561,957

(22) Filed: Dec. 26, 2021

Related U.S. Application Data
(60) Provisional application No. 63/130,852, filed on Dec. 28, 2020.

(51) Int. Cl. B32B 3/02; B32B 7/08; B32B 7/12; B32B 27/06

(52) U.S. Cl. CPC B32B 3/02; B32B 7/08; B32B 2471/04; B32B 27/06; B32B 2307/726; B32B 7/12

(57) ABSTRACT

Described herein is a polymer vehicle oil concrete cover. The inventive concept is equipped with a rubber top mat with a grate assembly to let oil drip through, an oil catching mat, and a base mat that contains the oil and prevents oil from draining onto concrete. This device is reusable, weather-resistant, and may have an adhesive base. The inventive concept may contain concrete fasteners. Sides are sloped upward.

### CLAIM OF PRIORITY

This application claims priority to and the benefit of U.S. Provisional Application with Ser. No. 63/130,852, filed on Dec. 28, 2021, with the same title, which is hereby incorporated by reference in its entirety.

### FIELD OF THE INVENTION

The inventive concept relates generally to a vehicle oil concrete floor cover.

### BACKGROUND

Currently, there are a number of solutions for preventing concrete stains. One of these solutions attempts to utilize a towel, but this solution fails to meet the needs of the market because towels get dirty quickly. Another solution attempts to have someone clean the concrete, but this solution is similarly unable to meet the needs of the market because cleaning is expensive and time consuming. Still another solution seeks to utilize a standard rubber mat, but this solution also fails to meet market needs because rubber mats may spill at the edges. Therefore, there currently exists a need in the market for an apparatus that a car oil catching mat.

### SUMMARY OF THE INVENTION

A vehicle oil concrete cover has a substantially planar polymer base mat member with an interior base mat portion contiguously circumscribed by at least one sidewall portion. An interior portion of the at least one sidewall portion is perpendicularly disposed from the interior base mat portion. An outer portion of the at least one sidewall portion is sloped outward from a top rim of the sidewall portion to an outer lower edge portion of the polymer base mat member at an acute angle to the interior sidewall portion, the at least one sidewall portion substantially solid between the inner and outer sidewall portions. At least one oil absorbent mat member is disposed planarly atop a top surface of the interior base mat portion of the base mat member. A substantially planar polymer top mat member is designed to be disposed atop the oil absorbent mat member and substantially contained within the interior portion of the polymer base mat member. The inventive concept includes an at least one side portion of the substantially planar polymer top mat member, a plurality of grate members internal to the at least one side portion of the substantially planar polymer top mat member to form a plurality of vertical channel members through the top mat member, an outer portion of the side portion of the polymer top mat member contiguously abutting the interior wall portion of the sidewall portion of the polymer base mat member. At least one helically threaded fastener member is disposed through the planar polymer top mat member and designed to couple the planar polymer top mat member to the planar polymer base mat member.

In one embodiment of the vehicle oil concrete cover, an adhesive compound is disposed on a bottom portion of the polymer base mat member, a removable polymer film member covering the adhesive compound.

In one embodiment of the vehicle oil concrete cover, at least one concrete anchor screw member is disposed through the bottom portion of the polymer base mat member.

In one embodiment of the vehicle oil concrete cover, the base mat member, interior base mat portion, and top mat member are substantially rectangular.

It would be advantageous to have a vehicle oil concrete cover that is reusable. Furthermore, it would also be advantageous to have a vehicle oil concrete cover that is adhesive. Still further, it would be advantageous to have a vehicle oil concrete cover that is weather-resistant.

The inventive concept advantageously fills the aforementioned deficiencies by providing a car oil concrete cover, which provides a way to prevent concrete from being stained.

The inventive concept is a car oil catching mat for concrete.

The vehicle oil concrete cover may have an adhesive bottom.

The vehicle oil concrete cover may have concrete anchors.

One of ordinary skill in the art would recognize that the inventive concept can also be used on asphalt, brick, stone, or other surfaces.

The vehicle oil concrete cover fulfills the need for a car oil catcher.

Among other things, it is an advantage of the vehicle oil concrete cover to provide a car oil concrete cover that does not suffer from problems or deficiencies associated with prior solutions.

It is still further an advantage of the vehicle oil concrete cover to be weather-resistant.

Still further, the vehicle oil concrete cover has a replaceable oil catching mat. This mat may be made from a natural or synthetic fiber or may have natural and synthetic fibers sewn into a polymer base.

The inventive concept now will be described more fully hereinafter with reference to the accompanying drawings, which are intended to be read in conjunction with both this summary, the detailed description and any preferred and/or particular embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete, and will fully convey the full scope of the inventive concept to those skilled in the art.

### BRIEF DESCRIPTION OF THE DRAWINGS

FIG. 1 illustrates the side of the vehicle oil concrete cover.

FIG. 2 illustrates the front of the vehicle oil concrete cover.

FIG. 3 illustrates the bottom of the vehicle oil concrete cover.

FIG. 4 illustrates the top of the vehicle oil concrete cover.

FIG. 5 illustrates the perspective view of the vehicle oil concrete cover.

FIG. 6 illustrates the interior portions of the vehicle oil concrete cover.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

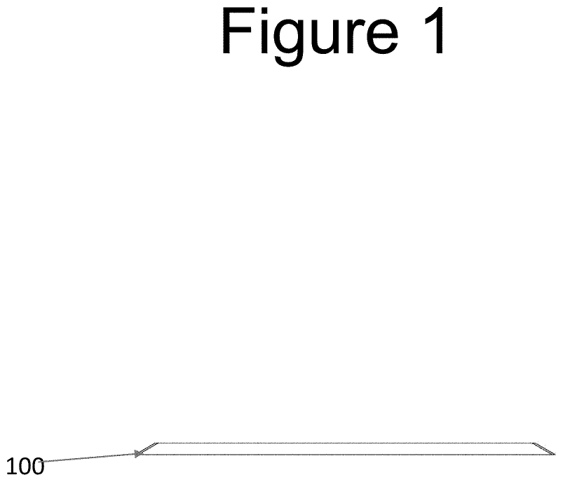

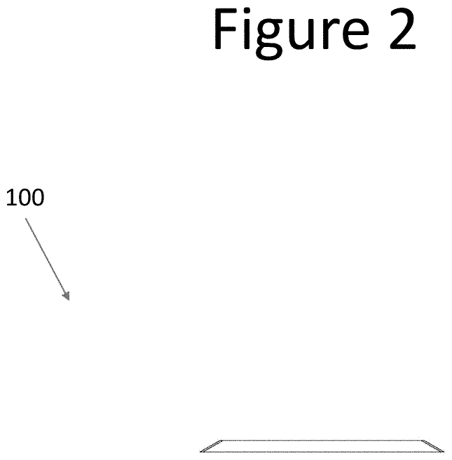

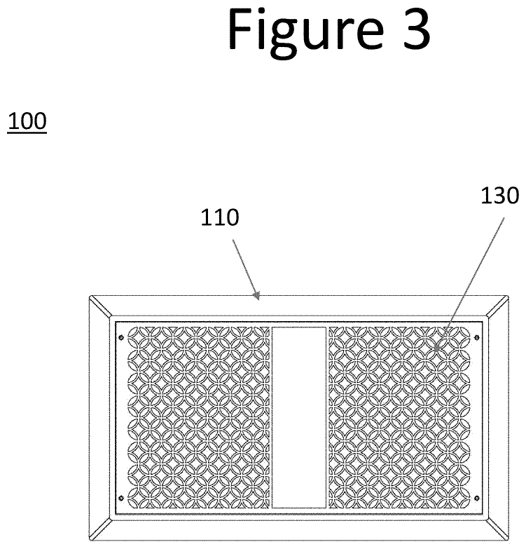

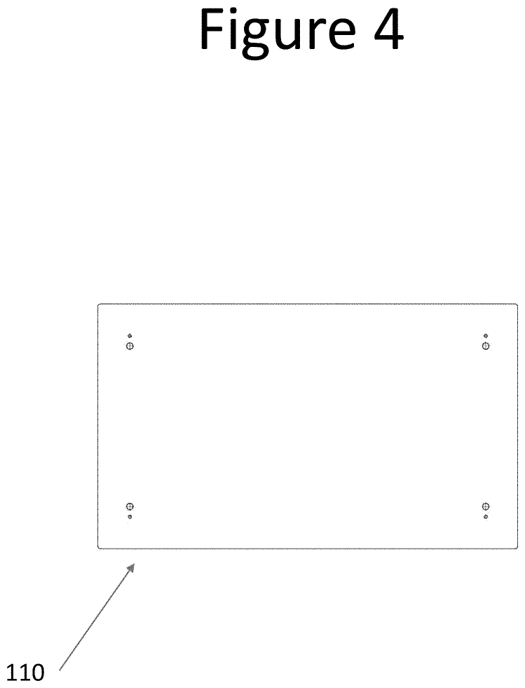

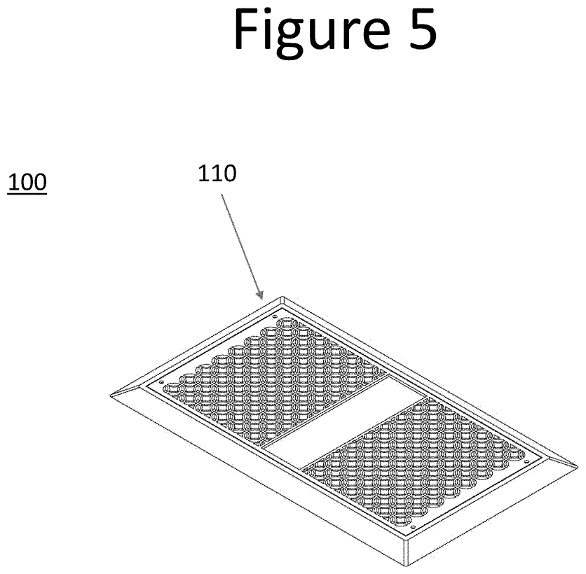

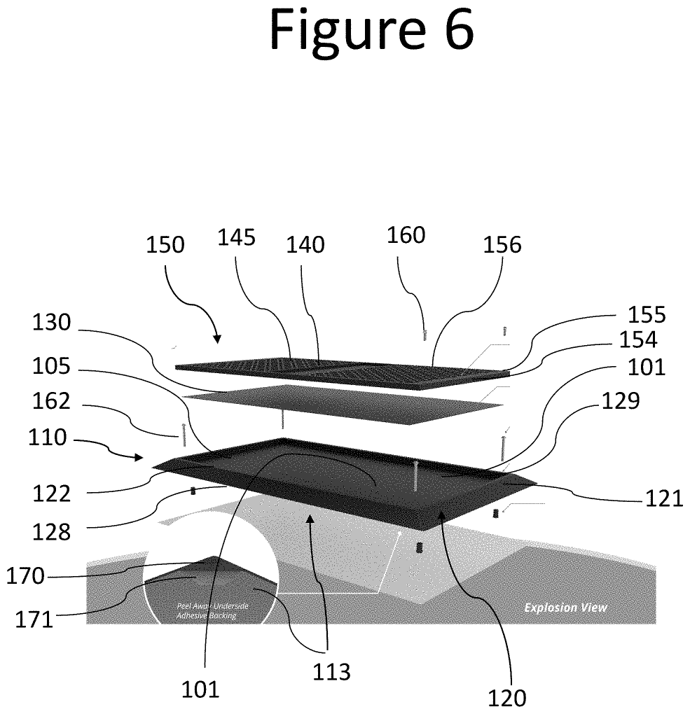

Referring to the figures, FIGS. 1-6 illustrate a vehicle oil concrete cover 100 that has a substantially planar polymer base mat member 110 with an interior base mat portion 105 contiguously circumscribed by at least one sidewall portion 120. An interior portion of the at least one sidewall portion 129 is perpendicularly disposed from the interior base mat portion 105. An outer portion of the at least one sidewall portion 121 is sloped outward from a top rim of the sidewall portion 122 to an outer lower edge portion 128 of the polymer base mat member 110 at an acute angle to the interior sidewall portion 129, the at least one sidewall portion 120 substantially solid between the inner and outer sidewall portions 129, 121. At least one oil absorbent mat member 130 is disposed planarly atop a top surface of the interior portion of the base mat member 101. A substantially planar polymer top mat member 150 is designed to be disposed atop the oil absorbent mat member 130 and substantially contained within the interior base mat portion 105 of the polymer base mat member 110.

An at least one side portion of the substantially planar polymer top mat member 155 has a plurality of grate members 140 internal to the at least one side portion of the substantially planar polymer top mat member 155 to form a plurality of vertical channel members 145 through the top mat member 150, an outer portion of the side portion of the polymer top mat member 154 contiguously abutting the interior wall portion of the sidewall portion 129 of the polymer base mat member 110. At least one helically threaded fastener member 160 is disposed through the planar polymer top mat member 150 and designed to couple the planar polymer top mat member 150 to the planar polymer base mat member 110.

In one embodiment of the vehicle oil concrete cover, an adhesive compound 170 is disposed on a bottom portion of the polymer base mat member 113, a removable polymer film member 171 covering the adhesive compound 170.

In one embodiment of the vehicle oil concrete cover, at least one concrete anchor screw member 162 is disposed through the bottom portion of the polymer base mat member 113.

In one embodiment of the vehicle oil concrete cover, the base mat member 110, interior base mat portion 101, and top mat member are substantially rectangular 150.

The following patents are incorporated by reference in their entireties: U.S. Pat. Nos. 2,512,310, 5,417,310, and 6,589,631.

While the inventive concept has been described above in terms of specific embodiments, it is to be understood that the inventive concept is not limited to these disclosed embodiments. Upon reading the teachings of this disclosure, many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

1. Vehicle oil concrete cover comprising:
a substantially planar polymer base mat member with an interior base mat portion contiguously circumscribed by at least one sidewall portion, an interior portion of the at least one sidewall portion perpendicularly disposed from the interior base mat portion;
an outer portion of the at least one sidewall portion sloped outward from a top rim of the sidewall portion to an outer lower edge portion of the polymer base mat member at an acute angle to the interior sidewall portion, the at least one sidewall portion substantially solid between the inner and outer sidewall portions;
at least one oil absorbent mat member disposed planarly atop a top surface of the interior portion of the base mat member;
a substantially planar polymer top mat member adapted to be disposed atop the oil absorbent mat member and substantially contained within the interior base mat portion of the polymer base mat member, an at least one side portion of the substantially planar polymer top mat member, a plurality of grate members internal to the at least one side portion of the substantially planar polymer top mat member to form a plurality of vertical channel members through the top mat member, an outer portion of the side portion of the polymer top mat member contiguously abutting the interior wall portion of the sidewall portion of the polymer base mat member; and
at least one helically threaded fastener member disposed through the polymer top mat member and adapted to couple the planar polymer top mat member to the polymer base mat member.

2. The vehicle oil concrete cover of claim 1 wherein an adhesive compound is disposed on a bottom portion of the polymer base mat member, a removable polymer film member covering the adhesive compound.

3. The vehicle oil concrete cover of claim 1 wherein at least one concrete anchor screw member is disposed through the bottom portion of the polymer base mat member.

4. The vehicle oil concrete cover of claim 1 wherein the base mat member, interior base mat portion, and top mat member are substantially rectangular.
